(19) United States
(12) Patent Application Publication
(10) Pub. No.: US 2003/0035086 A1
(43) Pub. Date: Feb. 20, 2003

(54) Real image projection device incorporating e-mail register

(76) Inventors: Douglas L. Robinson, Ithaca, NY (US); Kenneth S. Westort, Ithaca, NY (US)

Correspondence Address: BROWN & MICHAELS, PC, 400 M & T BANK BUILDING, 118 NORTH TIOGA ST, ITHACA, NY, 14850, US

(21) Appl. No.: 10/177,873

(22) Filed: Jun. 21, 2002

Related U.S. Application Data
(63) Continuation-in-part of application No. 09/933,331, filed on Aug. 20, 2001.
(63) Continuation-in-part of application No. 09/946,183, filed on Sep. 5, 2001.
(63) Continuation-in-part of application No. 10/126,167, filed on Apr. 19, 2002.

(51) Int. Cl. G03B 21/00

(52) U.S. Cl. 353/10

(57) ABSTRACT

An improved real image projection device includes a real image projection system for projecting a real image from one or more sources that transmit, reflect or emit light, and an e-mail capture system that includes a computer, microprocessor device, memory, or other device for storing an e-mail database, and a keyboard, touch-screen device, or pointing device and display monitor, or other input device, arranged for a viewer of the real image to enter one or more e-mail addresses into the database.

### REFERENCE TO RELATED APPLICATIONS

This is a continuation-in-part patent application of copending application Ser. No. 09/933,331, filed Aug. 20, 2001, entitled “IMAGE ENHANCEMENT IN A REAL IMAGE PROJECTION SYSTEM, USING ON-AXIS REFLECTORS, AT LEAST ONE OF WHICH IS ASPHERIC IN SHAPE”, copending application Ser. No. 09/946,183, filed Sep. 5,2001, entitled “METHOD AND APPARATUS FOR IMAGE ENHANCEMENT AND ABERRATION CORRECTIONS IN A SMALL REAL IMAGE PROJECTION SYSTEM, USING AN OFF-AXIS REFLECTOR, NEUTRAL DENSITY WINDOW, AND AN ASPHERIC CORRECTED SURFACE OF REVOLUTION”, and copending application Ser. No. 10/126,167, filed Mar. 19, 2002, entitled “METHOD OF GHOST REDUCTION AND TRANSMISSION ENHANCEMENT FOR A REAL IMAGE PROJECTION SYSTEM”. The aforementioned applications are hereby incorporated herein by reference.

### BACKGROUND OF THE INVENTION

1. Field of the Invention

The invention pertains to the field of optical displays. More particularly, the invention pertains to apparatus and methods for enhancement of a real image projection system, including a system for capturing viewers' e-mail addresses.

2. Description of Related Art

The present invention pertains to a real image projection system and, in particular, to such a system in which a real image of a three-dimensional object or a two-dimensional source, such as, for example, a photograph or computer screen, is formed in space, giving the illusion that a real object exists at that point in space, when in reality it does not.

Visual display systems are well known in the art and typically use a curved reflector with a beamsplitter positioned at a 45 degree angle to the curved reflector's optical axis to divert the input beam path at a 90 degree angle to the viewing axis or imaging beam path. This method has been used since the early 1950s for flight simulation, and commonly is referred to as the WAC window system. These systems typically are used in an on-axis configuration, meaning that the optical axis, or the un-tilted curved reflector's center of radius, is located along the viewing axis. When viewing such an on-axis system, any object within the viewing area images within the system.

One of the earliest working real image displays is depicted in White's 1934 publication of “Fundamentals of Optics”. It shows a spherical mirror positioned behind a table. A flower vase is mounted below the table and a real image of the vase is projected sitting on the table-top. In the late 1980's, real image display systems were further developed, typically consisting of two on-axis parabolic reflector segments, as described in U.S. Pat. No. 4,802,750. In the early 1990's, similar systems were built that use a beamsplitter having high reflection and low transmission, in order to reduce ghosting effects. By 1999, a system was developed using a circularly-polarized window in an on-axis, WAC window-style configuration. For example, U.S. Pat. No. 6,163,408 was issued in 2000. Later, a tilted system was developed, using an off-axis, curved reflector, as disclosed in International Patent Application No. PCT/US00/11234 and PCT Publication No. WO 00/65844. That system comprises a curved reflector tilted at an angle between 5 and 20 degrees from the viewing axis. A beamsplitter is positioned along the viewing axis, tilted at 45 degrees to the curved reflector's axis.

With the development of such high-transmission real imaging systems, many new enhancements are possible. One device that enhances a real image system is an invention that is referred to herein as an e-mail register kiosk, or simply e-mail register.

### SUMMARY OF THE INVENTION

The present invention pertains to a real image projection system in which a real image of a three-dimensional object or a two-dimensional source, such as, for example, a photograph or computer screen, is formed in space, giving the illusion that a real object exists at that point in space, when in reality it does not. The invention provides a real image projection system incorporating an e-mail capture system, and is referred to generally as an e-mail register kiosk.

Briefly stated, an improved real image projection device comprises a real image projection system for projecting a real image, and an e-mail capture system for establishing a database of e-mail addresses entered by viewers of said real image.

In an embodiment of the invention, an improved real image projection device comprises a real image projection system for projecting a real image, and an e-mail capture system comprising a computer, microprocessor device, memory, or other means for storing said database, and a keyboard, touch-screen device, or pointing device and display monitor, or other input means, arranged for a viewer of said real image to enter one or more e-mail addresses into said database. As a viewer approaches the floating real image produced by the real image projection system, the input device is provided, preferably a touch-screen display (e.g., optionally located under the real image window), wherein an image of a keyboard is displayed to the viewer. The touch-screen display optionally displays advertising and/or prompts the viewer to enter the viewer's e-mail address to receive various free promotional items.

### BRIEF DESCRIPTION OF THE DRAWING

FIG. 1 shows an embodiment of the e-mail register kiosk of the present invention including a real image projection system.

FIG. 2 shows an embodiment of the e-mail register kiosk including a real image projection system utilizing two curved reflectors.

FIG. 3 shows an embodiment of the e-mail register kiosk including a real image projection system utilizing a tilted reflector optical system.

FIG. 4 shows an embodiment of the e-mail register kiosk including a tilted optic real image projection system.

FIG. 5 shows a photo-screen for use with the e-mail register kiosk of the present invention, comprising a transparent or semi-transparent material having a fixed or static image applied to the surface thereof. In an embodiment of the invention, the photo-screen is positioned so as to intersect a real image beampath of the real image projection device.

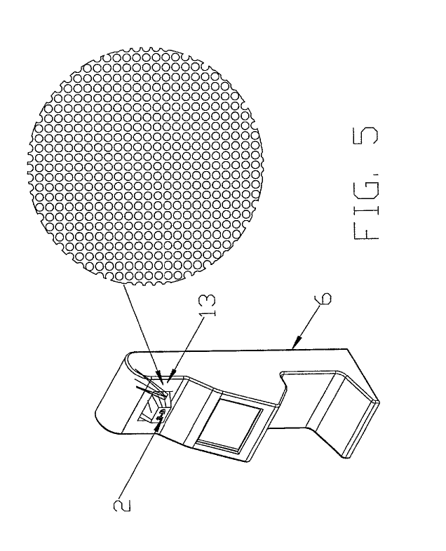

### DETAILED DESCRIPTION OF THE INVENTION

The present invention provides an improved real image projection device, of the type in which an image of a real object is formed in space, giving the illusion that a real object exists at that point in space, when in reality it does not.

A preferred embodiment of the present invention provides a real image projection device comprising a real image projection system, means for storing data, such as a computer or simply a microprocessor, and input means, such as a keyboard, but preferably a touch-screen display or interactive input device, for a viewer to enter data, such as an e-mail address. The real image projection system attracts the attention of viewers or potential customers, by projecting one or more images into a space near the real image projection device, giving the illusion that something exists at that point in space, when in reality it does not. In a preferred embodiment, the invention provides a relatively small kiosk presenting a moving image or video presentation, appearing as a 3-D image floating in viewer space, or in front of the kiosk. As a viewer approaches the floating 3-D image, an input device is provided, preferably a touch-screen display (e.g., optionally located under the real image window), for example, wherein an image of a keyboard is displayed to the viewer. The touch-screen display optionally displays advertising and/or prompts the viewer to enter the viewer's e-mail address to receive various free promotional items.

A typical e-mail register kiosk preferably includes a small footprint cabinet or enclosure, with a real image projection device installed inside, and a view window or aperture located at approximately eye level to a viewer standing in front of the cabinet. The real image projector preferably provides a floating foreground image, preferably generated from a CRT, and an optional virtual background image, preferably generated from a second CRT, LCD, or gas plasma display. The two monitors preferably are driven by a video signal from a computer located inside the enclosure. Input means, preferably a touch-screen LCD panel or CRT located below the real image window, is interfaced with a computer or microprocessor, preferably the same computer or microprocessor.

The computer that drives the three monitors should be capable of outputting one or two video NTSC signals, preferably in Mpeg-1 or Mpeg-2 formats. It also should include means for storing video files, preferably a hard drive. One example for outputting the required signals includes the use of a dual-channel Mpeg-2 decoder card, which is available commercially, plus a standard video card to supply a VGA signal. Optionally, some of the available VGA cards have composite outputs in addition to VGA. In cases where no background image is required or desired, one of these cards optionally is used to output a single Mpeg composite signal to the monitor, and a VGA signal to the touch-screen display. However, one of ordinary skill in the art will understand that many hardware solutions are possible, depending upon the specific requirements of the system to be deployed.

The software for operating the system preferably accomplishes several functions. It should be able to interface with the user and provide a user-friendly method of entering e-mail addresses. One such method is to provide a touch-screen image of a keyboard. Preferably, the method of entry of an e-mail address is both simple and fun. The computer also should be able to output a video signal, preferably in Mpeg-1 or Mpeg-2 format, or other video format, preferably while simultaneously operating the virtual keyboard on the touch-screen display. This can be accomplished with a software decoder outputting through the composite port of a TV-Video card, as will be understood by one of ordinary skill in the art. In cases where a synchronized foreground and background image are required, the optimum solution is the use of a dual Mpeg decoder card.

Preferably the computer automatically starts on power-up of the system, and should be operational without any manual setup. For example, in cases where a Windows based operating system is used, one or more applets should be written to automatically load and run the various programs required, and perform the necessary functions, such as storing e-mail addresses in a database, and for remote access from a central location.

The computer optionally includes a modem or network card, providing for e-mail addresses to be transferred to a central remote database. The modem system may be any form such as, but not limited to, DSL, cable, T-1, T-3, telephone, or any other form capable of data transmission and receipt. The modem preferably is connected to a broadband service, such as cable modem or DSL, however, standard 56k modem service will suffice, for example, if the video files are not installed or updated from a remote location. In cases where the e-mail register kiosk systems are installed in a chain of restaurants or commercial facilities, the video content or 3-D graphic content optionally is uploaded to individual locations from a remote central location on a regular basis. The email addresses accumulated preferably also are downloaded to the central database.

While the preferred embodiment comprises a computer for processing and storage of e-mail addresses, it is emphasized that a computer is not required. Alternatively, a simple microprocessor or memory unit is used for storage and retrieval of e-mail addresses and/or other data, as will be clear to one of ordinary skill in the art.

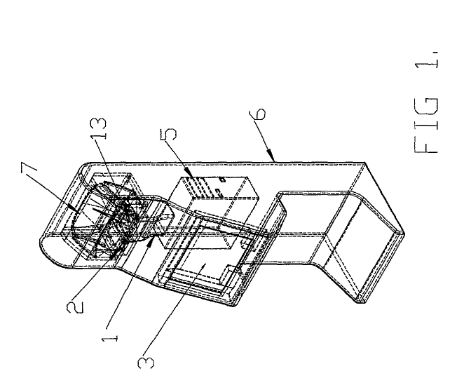

Referring now to FIG. 1, an embodiment of an e-mail register kiosk including a real image projection system is shown. The unit consists of a kiosk housing (6), preferably containing all of the system components. The real image projection system containing the imaging optics (7) is positioned so that the real image (2) floats out in front of the kiosk (6) in viewer space. The image source, preferably a 3-D target monitor (1) is located inside the kiosk (6). Light emitted from the monitor screen (1) is collected by the real image optical system (7) and is then projected through the image window (13), forming a real image (2) in viewer space in front of the window (13). A second monitor (3) preferably is positioned at approximately waist level for viewer input. The second monitor preferably is a touch-screen (3) input device, but optionally is any suitable input device. Both monitors (1,3) preferably are connected to a control device, such as a microprocessor or computer (5). The computer outputs video to the real image projection system monitor (1), while simultaneously interfacing with the viewer through the touch-screen display (3).

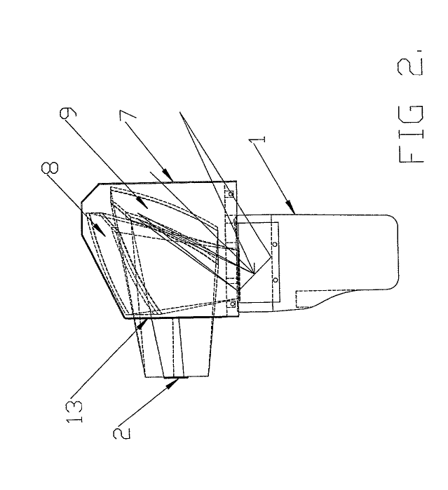

FIG. 2 depicts an alternative embodiment of the e-mail register kiosk of the present invention, including a typical real image projection system comprising a dual curved optic system using two curved reflectors (8,9) mounted into a housing (7), with a CRT (1) as a target or image source. The optical reflectors (8,9) gather the light beams emanating from the CRT (1), and refocus it into a converging beam, passing through the window opening (13) and forming a real image (2) in viewer space outside of the housing (7).

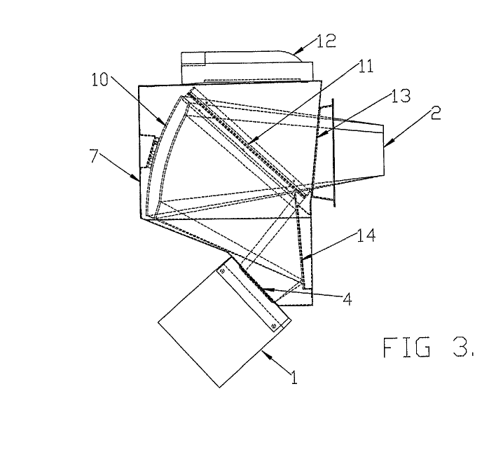

FIG. 3 depicts an alternative embodiment of the e-mail register kiosk of the present invention, including a typical real image projection system comprising a tilted off-axis single curved reflector (10), a fold mirror (14) to redirect the input light beam from the monitor (1) or image source located at the focal point (4) of the system. A secondary monitor (12) optionally is used in conjunction with a beamsplitter (11) to create a virtual image floating just inside the window opening (13), visible behind the floating real image (2). This system includes two video inputs from the e-mail kiosk computer, when incorporating a background display (12).

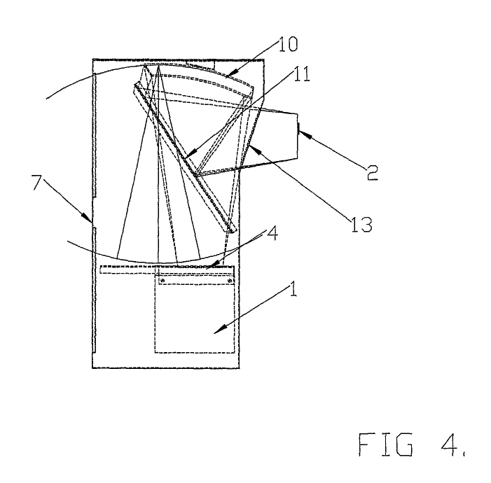

FIG. 4 depicts an alternative embodiment of the e-mail register kiosk of the present invention, including a typical real image projection system comprising a tilted off-axis curved reflector (10). In this configuration, the diverging light beam from the monitor (4) or real image source, passes through the beamsplitter (11), striking the tilted curved reflector (10). The light is then reflected as a converging light beam and reflects off of the beamsplitter (11), passing through the window aperture (13) and forming a real image (2) in viewer space. This particular system has less light transmission than the system shown in FIG. 3, but is acceptable for use in the e-mail register kiosk.

There are several business models in which the e-mail register kiosk systems can be used. One example of such a business model is to contract with an establishment, such as a hotel chain, deploying a system in each of the chain's hotels. The cost of the systems and installation preferably is shared with the hotel chain, and, for example, each hotel preferably would pay a monthly service fee. The hotel chain preferably purchases services, such as, for example, video production of new advertisements, for the real image display on a regular basis, and accumulation and maintenance of a database of e-mail addresses or other information. The individual hotels preferably would then review their bookings and select specific dates, for example, when they have high vacancy rates. Normally, the hotel would be forced to offer the vacancies to a consolidator on consignment, typically at a greatly discounted rate. Alternatively, however, when using the present system, the hotel notifies the database administrator that it wishes to fill a certain number of vacancies on specific dates, at a certain discounted price, and the administrator performs a mass e-mailing to individuals who entered their e-mail addresses into the database. This service optionally is offered on a fee basis or on a commission basis.

In another business model example, the e-mail register kiosk is placed in an individual hotel or multiple hotels in a hotel chain, or other hospitality establishment, to gather e-mail addresses of people staying at the hotel, and optionally, for example, offering to notify them of special deals and vacation packages. For example, when the hotel has a weekend with a high rate of vacancies, e-mails are sent out offering a special rate for that weekend, including, for example, free breakfast or other promotional offers. Hotels can then directly sell their vacancies, rather than consign the vacant rooms to consolidators at a discount. The real image display not only attracts viewers or potential customers and prompts them to enter e-mail addresses, but also can advertise hotel services and events. In addition, for example, the kiosk optionally includes interactive features, for example, providing many of the services and functions of a concierge. For example, the same interactive interface between the touch-screen and the real image display optionally allows hotels guests to scroll through various hotel activities that are available, thereby serving as an electronic concierge. By entering their e-mail address and room number, the guest could, for example, directly book activities and tours, billing them to their room.

In another business model example, the e-mail register kiosk is placed in an individual restaurant or multiple restaurants in a chain (e.g., “fast-food” franchise), or other food service establishment, wherein the kiosk plays, for example, a 3-D video of an advertisement for the restaurant and projects a floating real image of a trademark character prompting the viewer to enter the viewer's e-mail address in return for free coupons, for example. Optionally, viewers who enter their e-mail address periodically receive e-mail providing coupons, such as for restaurant discounts or free items. The e-mail coupons optionally are provided as redeemable only at a specific restaurant within a chain.

The e-mail register optionally offers other services as well. For example, in the case of a restaurant chain, the touch-screen display optionally directly controls the 3-D real image and is entirely interactive. For example, the menu is presented by pressing a menu button on the touch-screen, and the various food items are shown as a floating 3-D real image rotating in space in front of the viewer.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A real image projection apparatus, comprising:
a real image projection system for projecting a real image from one or more sources that transmit, reflect or emit light; and
an e-mail capture system for establishing a database of e-mail addresses entered by viewers of said real image.

2. The apparatus of claim 1, wherein said e-mail capture system comprises:
a computer, microprocessor device, memory, or other means for storing said database; and
a keyboard, touch-screen device, or pointing device and display monitor, or other input means, arranged for a viewer of said real image to enter one or more e-mail addresses into said database.

3. The apparatus of claim 2, wherein said input means comprises an interactive touch screen CRT or LCD monitor, or a CRT or LCD monitor and keyboard or pointing device.

4. The apparatus of claim 2, further comprising a modem or network card, or other means for remote access of said database, and/or for transferring video or other files to or from a remote location, and/or general communication with a remote location.

5. The apparatus of claim 2, wherein said source comprises a real object, a video monitor, computer monitor, or projection screen, or other source that transmits, reflects or emits light.

6. The apparatus of claim 5, wherein said real image projection system comprises an optical system, which inputs diverging light from said source, refocuses said diverging light into a converging beam, and then forms a real image of said source in a space in front of said real image projection apparatus.

7. The apparatus of claim 6, wherein said source comprises at least one target monitor and said real image projection system further comprises means for providing at least one electronic video signal to said at least one target monitor.

8. The apparatus of claim 7, wherein said video signal is provided by a DVD player, laser disk player, computer, and/or other video means, interfaced with a computer and/or computer driven controller.

9. The apparatus of claim 8, wherein said computer and/or computer driven controller has one or more VGA outputs and/or video outputs.

10. The apparatus of claim 9, wherein said one or more video outputs are NTSC, PAL, S-Video, composite, RGB, and/or other format compatible with said real image projection system.

11. The apparatus of claim 9, wherein said one or more video outputs are Mpeg-1, Mpeg-2, or AVI format, or other video output from stored data.

12. The apparatus of claim 8, wherein said computer and/or computer driven controller is built into a video output device, or a video device including an RS-232 port or serial port or other connector for providing communication with an external controller or computer.

13. The apparatus of claim 7, wherein at least two video files, one being a foreground video and another being a background video, are stored on a hard drive or other digital storage device, and outputted to two video monitors as video signals synchronized with each other, thus keeping said background video synchronized with said foreground video.

14. The apparatus of claim 2, further comprising computer-controlled means for direct control and/or manipulation of said real image projection system and/or said database.

15. The apparatus of claim 14, wherein said computer-controlled means comprises a computer or microprocessor, and further comprising software for control and/or manipulation of said real image projection system and/or said database.

16. The apparatus of claim 14, wherein said control and/or manipulation of said real image projection system includes product selection or selection of items from a screen list or a virtual catalog display.

17. The apparatus of claim 14, wherein said manipulation of said real image projection system includes control of said real image or selection of different images or video tracks displayed by said real image projection system.

18. The apparatus of claim 14, wherein said source is a 3-D solid model with photo-matted surfaces, outputted to a target monitor and controlled through a software program.

19. The apparatus of claim 15, wherein said software comprises a commercial software package, and/or one or more custom applets, or other custom control software.

20. The apparatus of claim 19, wherein said software includes an e-mail register applet to allow said viewer to enter one or more e-mail addresses into said database, through said input device.

21. The apparatus of claim 19, wherein said software monitors inputs from said viewer and controls and/or manipulates said real image to create an interactive experience.

22. The apparatus of claim 19, wherein said software includes an applet to control a video output or select and play a specific video file from a series of video files.

23. The apparatus of claim 22, wherein said selection of said video file is based upon said viewer's input to said input device.

24. The apparatus of claim 15, wherein two video signals are played in synchronization, one foreground real image and a second background image.

25. The apparatus of claim 24, wherein said control software maintains synchronization of said video files while playing, and/or selects video files in pairs of foreground and corresponding background.

26. The apparatus of claim 15, wherein said e-mail addresses are stored in a database file, and said software has sufficient error-trapping routines so as to create a substantially stable and reliable platform.

27. The apparatus of claim 15, wherein said database is uploaded to a remote location.

28. The apparatus of claim 27, wherein said upload is accomplished through a subroutine, which automatically transmits said data at preselected times, or accepts instructions from a remote location to upload said data.

29. A method for promoting goods or services, comprising the steps of:
deploying an e-mail register kiosk in an establishment, wherein said e-mail register kiosk includes a real image projection system for projecting a real image from one or more sources that transmit, reflect or emit light;
prompting viewers of said real image to enter one or more e-mail addresses;
establishing a database of said e-mail addresses; and
promoting said goods or services by directing promotions to selected e-mail addresses in said database.
